(19) United States
(12) Patent Application Publication
(10) Pub. No.: US 2012/0117383 A1
(43) Pub. Date: May 10, 2012

(54) System and Method for Secure Device Configuration Cloning

(75) Inventor: Min S. Kim, Cerritos, CA (US)

(73) Assignees: Toshiba Tec Kabushiki Kaisha, Shinagawa-ku (JP); Kabushiki Kaisha Toshiba, Minato-ku (JP)

(21) Appl. No.: 12/939,970

(22) Filed: Nov. 4, 2010

(51) Int. Cl. H04L 9/00; H04L 9/32

(52) U.S. Cl. 713/165

(57) ABSTRACT

The subject application is directed to a system and method for secure device configuration cloning. Configuration data corresponding to software-settable configurations of a document processing device is received into a data storage. Schema data is generated on a processor in data communication with the data storage. The schema file includes segments and corresponds to a portion of the configuration data. At least one segment of the schema file is encrypted in accordance with a corresponding portion of the configuration data. Secure clone file data is then generated based upon the configuration data and the encrypted schema file and communicated to a second document processing device for configuration thereof.

### BACKGROUND

1. Field

The subject application is directed generally to cloning device configurations between document processing devices. The application is more particularly directed cloning of document processing devices securely to prevent tampering or corruption when communicating a configuration file between devices.

2. Description of the Related Art

Document processing devices in widespread use today include copiers, printers, facsimile devices, scanners, e-mail gateways, and the like. Today, two or more of these functions are frequently found in one device, referred to as a multifunction peripheral (MFP) or multifunction device (MFD). The many complex capabilities and functions of MFPs are frequently controlled by a digital processor, referred to as a controller. Settings are typically set to enable desired machine capabilities, set default parameters, initiate network connectivity, set address books, set workgroups, or any other setting or feature.

Many enterprises will use multiple MFPs. They will frequently choose similar devices from the same manufacturer to simplify maintenance, stocking of components, and familiarity of devices by their users. Rather than individually configure each of many devices, it is desirable to set one device, and copy its configuration settings to one or more similar devices.

### DESCRIPTION OF THE DRAWINGS

FIG. 1 is a FIG. 1 is an overall diagram of a system for secure device configuration cloning according to one embodiment of the subject application.

FIG. 2 is a block diagram illustrating device hardware for use in the system for secure device configuration cloning according to one embodiment of the subject application.

FIG. 3 is a functional diagram illustrating the device for use in the system for secure device configuration cloning according to one embodiment of the subject application.

FIG. 4 is a block diagram illustrating controller hardware for use in the system for secure device configuration cloning according to one embodiment of the subject application.

FIG. 5 is a functional diagram illustrating the controller for use in the system for secure device configuration cloning according to one embodiment of the subject application.

FIG. 6 is a functional diagram illustrating a workstation for use in the system for secure device configuration cloning according to one embodiment of the subject application.

FIG. 7 is a block diagram illustrating the system for secure device configuration cloning according to one embodiment of the subject application.

FIG. 8 is a functional diagram illustrating the system for secure device configuration cloning according to one embodiment of the subject application.

FIG. 9 is a flowchart illustrating a method for secure device configuration cloning according to one embodiment of the subject application.

FIG. 10 is a flowchart illustrating a method for secure device configuration cloning according to one embodiment of the subject application.

FIG. 11 is a flowchart illustrating an example of the generation of a clone data file using the method for secure device configuration cloning in accordance with one embodiment of the subject application.

FIG. 12 is a flowchart illustrating an example cloning operation based upon the clone data file of FIG. 11 in accordance with one embodiment of the subject application.

### DETAILED DESCRIPTION

Description of Apparatus

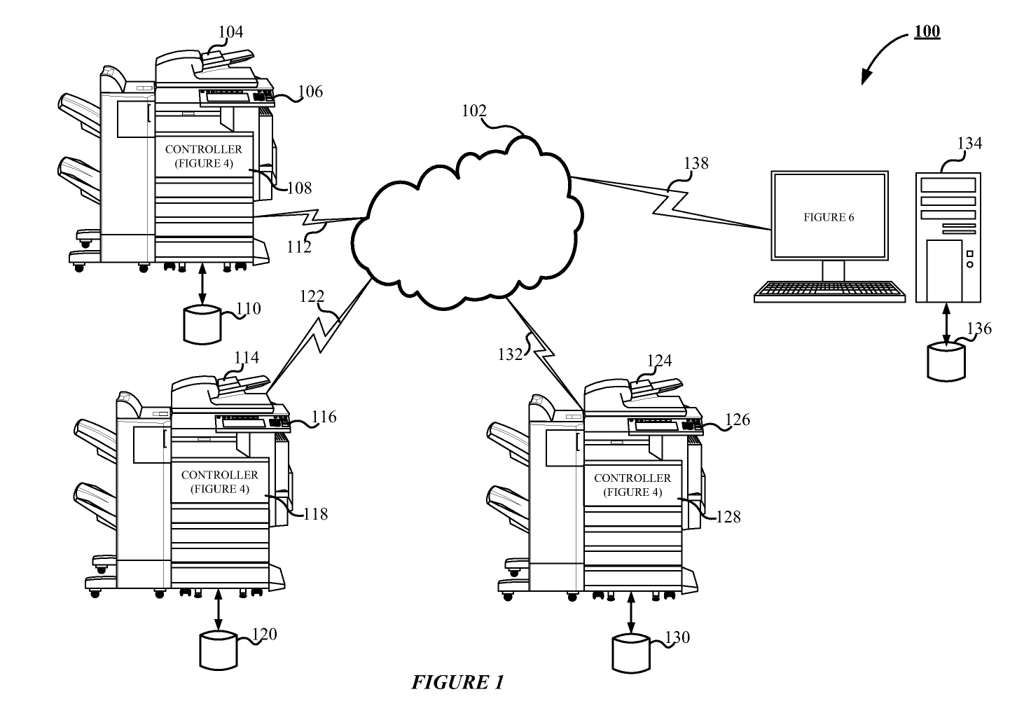

The subject application is directed to a system and method for secure device configuration cloning. The subject application is directed generally to cloning device configurations between document processing devices. The application is more particularly directed to the cloning of document processing devices securely to prevent tampering or corruption when communicating a configuration file between devices. It will become apparent to those skilled in the art that the system and method described herein are suitably adapted to a plurality of varying electronic fields employing automated configuration, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for secure device configuration cloning in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes one or more document processing devices, depicted in FIG. 1 as the document processing devices 104, 114, and 124. As shown in FIG. 1, the document processing devices 104, 114, and 124 are illustrated as multifunction peripheral devices, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing devices 104, 114, and 124 are suitably adapted to provide remote document rendering services to external or network devices. According to one embodiment of the subject application, the document processing devices 104, 114, and 124 include hardware, software, and any suitable combination thereof, configured to interact with an associated user, a networked device, or the like. Preferably, the document processing devices 104, 114, and 124 are capable of communicating electronic documents to and from each other in accordance with user provided instructions, transferring electronic documents amongst each other based upon output capabilities, locations, or the like.

According to one embodiment of the subject application, the document processing devices 104, 114, and 124 are suitably equipped to receive a plurality of portable storage media, including, without limitation, Firewire drive, USB drive, SD, MMC, XD, Compact Flash, Memory Stick, and the like. In the preferred embodiment of the subject application, the document processing devices 104, 114, and 124 further include associated user interfaces 106, 116, and 126, such as a touch-screen, LCD display, touch-panel, alpha-numeric keypad, or the like, via which an associated user is able to interact directly with the document processing devices 104, 114, and 124. In accordance with the preferred embodiment of the subject application, the user interfaces 106, 116, and 126 are advantageously used to communicate information to associated users and receive selections from such associated users.

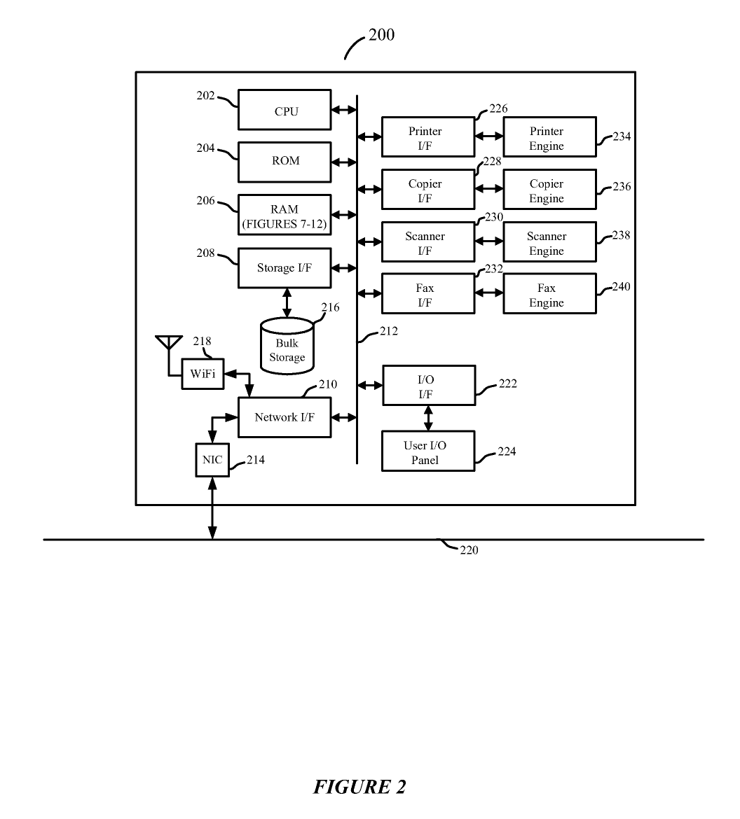

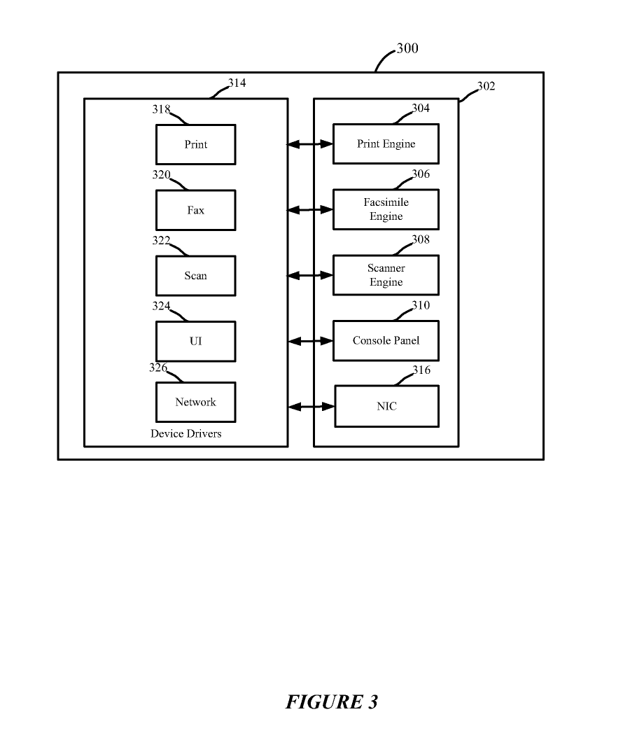

The skilled artisan will appreciate that the user interfaces 106, 116, and 126 comprise various components, suitably adapted to present data to associated users, as are known in the art. In accordance with one embodiment of the subject application, the user interfaces 106, 116, and 126 comprise a display, suitably adapted to display one or more graphical elements, text data, images, or the like, to an associated user, receive input from the associated user, and communicate the same to a backend component, such as controllers 108, 118, and 128, as explained in greater detail below. Preferably, the document processing devices 104, 114, and 124 are communicatively coupled to the computer network 102 via suitable communications links 112, 122, and 132. As will be understood by those skilled in the art, suitable communications links include, for example and without limitation, WiMax, 802.11a, 802.11b, 802.11 g, 802.11(x), Bluetooth, the public switched telephone network, a proprietary communications network, infrared, optical, or any other suitable wired or wireless data transmission communications known in the art. The functioning of the document processing devices 104, 114, and 124 will be better understood in conjunction with the block diagrams illustrated in FIGS. 2 and 3, explained in greater detail below.

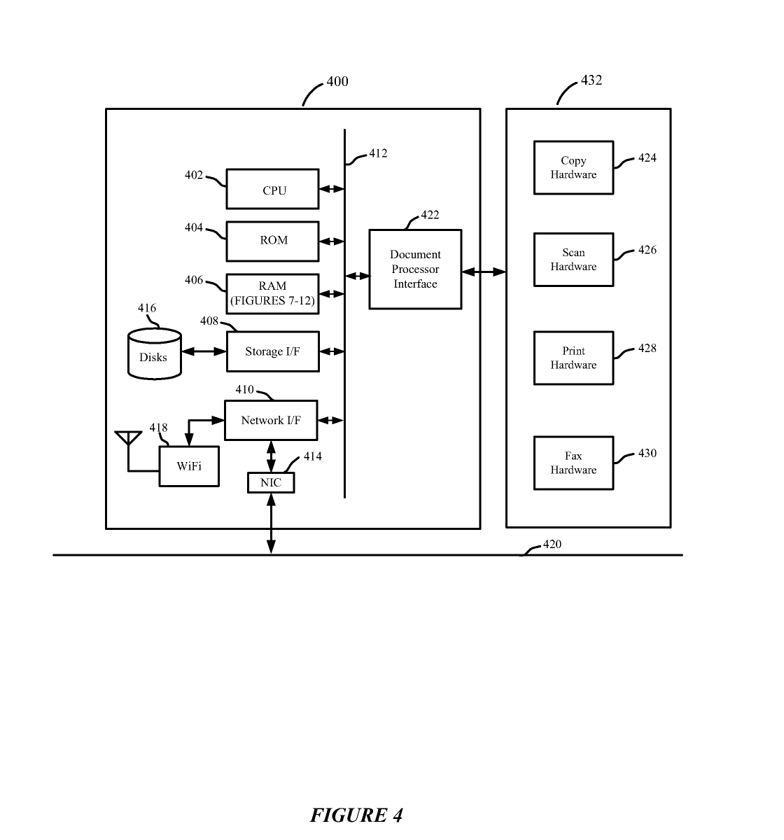

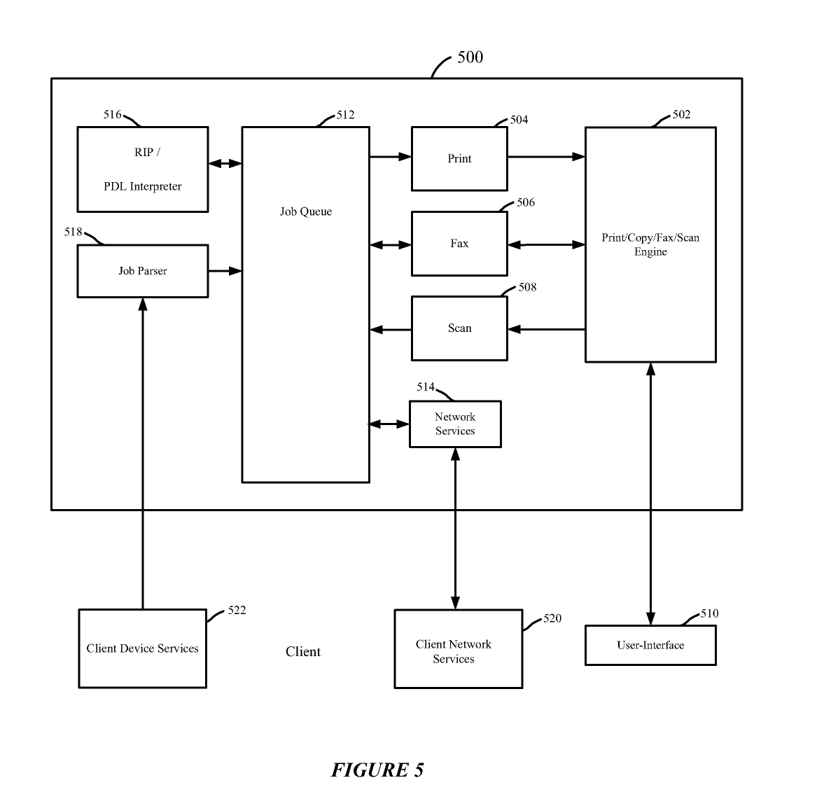

In accordance with one embodiment of the subject application, the document processing devices 104, 114, and 124 further incorporate a backend component, designated as the controllers 108, 118, and 128, suitably adapted to facilitate the operations of their respective document processing devices 104, 114, and 124, as will be understood by those skilled in the art. Preferably, the controllers 108, 118, and 128 are embodied as hardware, software, or any suitable combination thereof, configured to control the operations of the associated document processing devices 104, 114, and 124, facilitate the display of images via the user interfaces 106, 116, and 126, direct the manipulation of electronic image data, maintain the security of applications, user information, data, and the like. For purposes of explanation, the controllers 108, 118, and 128 are used to refer to any myriad of components associated with the document processing devices 104, 114, and 124, including hardware, software, or combinations thereof, functioning to perform, cause to be performed, control, or otherwise direct the methodologies described hereinafter. It will be understood by those skilled in the art that the methodologies described with respect to the controllers 108, 118, and 128 are capable of being performed by any general purpose computing system, known in the art, and thus the controllers 108, 118, and 128 are representative of such a general computing device and is intended as such when used hereinafter. Furthermore, the use of the controllers 108, 118, and 128 hereinafter is for the example embodiment only, and other embodiments, which will be apparent to one skilled in the art, are capable of employing the system and method for automated, peer-based configuration of network services of the subject application. The functioning of the controllers 108, 118, and 128 will better be understood in conjunction with the block diagrams illustrated in FIGS. 4 and 5, explained in greater detail below.

Communicatively coupled to the document processing devices 104, 114, and 124 are data storage devices 110, 120, and 130. In accordance with the preferred embodiment of the subject application, the data storage devices 110, 120, and 130 are any mass storage device known in the art including, for example and without limitation, magnetic storage drives, a hard disk drive, optical storage devices, flash memory devices, or any suitable combination thereof. In the preferred embodiment, the data storage devices 110, 120, and 130 are suitably adapted to store security levels, security software, document data, image data, electronic database data, or the like. It will be appreciated by those skilled in the art that while illustrated in FIG. 1 as being a separate component of the system 100, the data storage devices 110, 120, and 130 are capable of being implemented as internal storage components of the document processing devices 104, 114, and 124, components of the controllers 108, 118, and 128, or the like, such as, for example and without limitation, an internal hard disk drive, or the like.

Also depicted in FIG. 1 is a computer workstation 134 in data communication with the computer network 102 via a communications link 138. It will be appreciated by those skilled in the art that the workstation 134 is shown in FIG. 1 as a workstation computer for illustration purposes only. As will be understood by those skilled in the art, the workstation 134 is representative of any personal computing device known in the art including, for example and without limitation, a laptop computer, a personal computer, a personal data assistant, a web-enabled cellular telephone, a smart phone, a proprietary network device, or other web-enabled electronic device. According to one embodiment of the subject application, the workstation 134 further includes software, hardware, or a suitable combination thereof configured to interact with the document processing devices 104, 114, and 124, or the like. In one embodiment of the subject application, the workstation 134 includes one or more drivers suitably configured to interact with the document processing devices 104, 114, and 124, prepare electronic documents for output thereby, and the like, as will be understood by those skilled in the art.

The communications link 138 is any suitable channel of data communications known in the art including, but not limited to wireless communications, for example and without limitation, Bluetooth, WiMax, 802.11a, 802.11b, 802.11 g, 802.11(x), a proprietary communications network, infrared, optical, the public switched telephone network, or any suitable wireless data transmission system, or wired communications known in the art. Preferably, the workstation 134 is suitably adapted to provide document data, job data, user interface data, image data, monitor document processing jobs, employ thin-client interfaces, generate display data, generate output data, or the like, with respect to the document processing devices 104, 114, or 124, or any other similar device coupled to the computer network 102.

Communicatively coupled to the workstation 134 is the data storage device 136. According to the foregoing example embodiment, the data storage device 136 is any mass storage device, or plurality of such devices, known in the art including, for example and without limitation, magnetic storage drives, a hard disk drive, optical storage devices, flash memory devices, or any suitable combination thereof. In such an embodiment, the data storage device 136 is suitably adapted to store electronic document data, document processing device identification data, document processing device drivers, and the like. It will be appreciated by those skilled in the art that while illustrated in FIG. 1 as being a separate component of the system 100, the data storage device 136 is capable of being implemented as an internal storage component of the workstation 134, or the like, such as, for example and without limitation, an internal hard disk drive, or the like.

Turning now to FIG. 2, illustrated is a representative architecture of a suitable device 200, shown in FIG. 1 as the document processing devices 104, 114, and 124, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, Token-Ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by the bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing devices 104, 114, and 124, for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controllers 108, 118, and 128, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controllers 108, 118, and 128) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

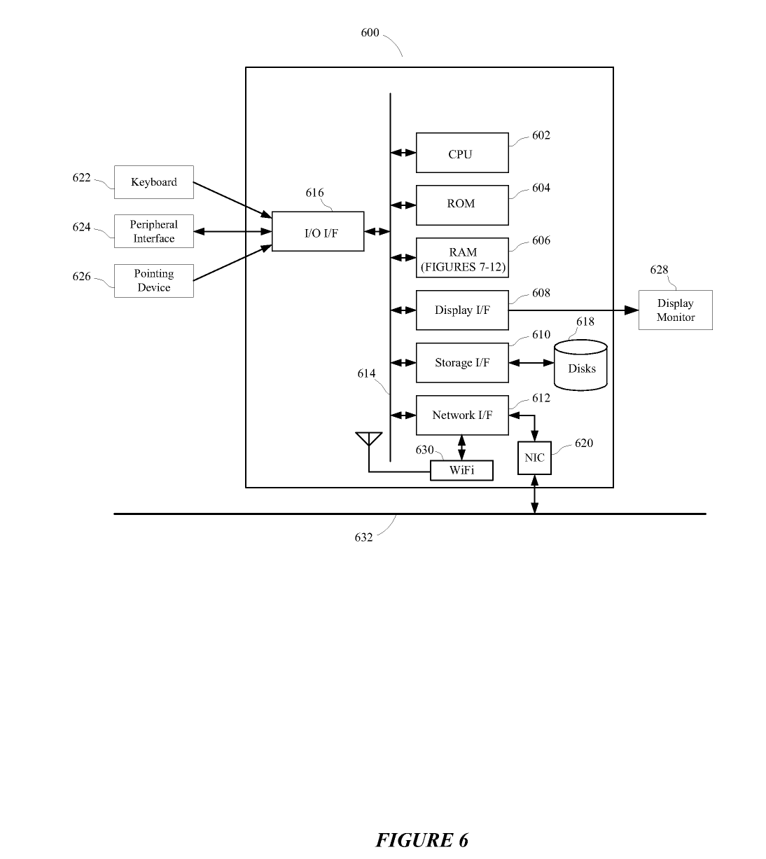

Turning now to FIG. 6, illustrated is a hardware diagram of a suitable workstation 600, shown as the computer workstation 134, for use in connection with the subject system. A suitable workstation includes a processor unit 602 which is advantageously placed in data communication with read only memory 604, suitably non-volatile read only memory, volatile read only memory or a combination thereof, random access memory 606, display interface 608, storage interface 610, and network interface 612. In a preferred embodiment, interface to the foregoing modules is suitably accomplished via a bus 614.

The read only memory 604 suitably includes firmware, such as static data or fixed instructions, such as BIOS, system functions, configuration data, and other routines used for operation of the workstation 600 via CPU 602.

The random access memory 606 provides a storage area for data and instructions associated with applications and data handling accomplished by the processor 602.

The display interface 608 receives data or instructions from other components on the bus 614, which data is specific to generating a display to facilitate a user interface. The display interface 608 suitably provides output to a display terminal 628, suitably a video display device such as a monitor, LCD, plasma, or any other suitable visual output device as will be appreciated by one of ordinary skill in the art.

The storage interface 610 suitably provides a mechanism for non-volatile, bulk or long term storage of data or instructions in the workstation 600. The storage interface 610 suitably uses a storage mechanism, such as storage 618, suitably comprised of a disk, tape, CD, DVD, or other relatively higher capacity addressable or serial storage medium.

The network interface 612 suitably communicates to at least one other network interface, shown as network interface 620, such as a network interface card, and wireless network interface 630, such as a WiFi wireless network card. It will be appreciated that by one of ordinary skill in the art that a suitable network interface is comprised of both physical and protocol layers and is suitably any wired system, such as Ethernet, Token-Ring, or any other wide area or local area network communication system, or wireless system, such as WiFi, WiMax, or any other suitable wireless network system, as will be appreciated by one of ordinary skill in the art. In the illustration, the network interface 620 is interconnected for data interchange via a physical network 632, suitably comprised of a local area network, wide area network, or a combination thereof.

An input/output interface 616 in data communication with the bus 614 is suitably connected with an input device 622, such as a keyboard or the like. The input/output interface 616 also suitably provides data output to a peripheral interface 624, such as a USB, universal serial bus output, SCSI, Firewire (IEEE 1394) output, or any other interface as may be appropriate for a selected application. Finally, the input/output interface 616 is suitably in data communication with a pointing device interface 626 for connection with devices, such as a mouse, light pen, touch screen, or the like.

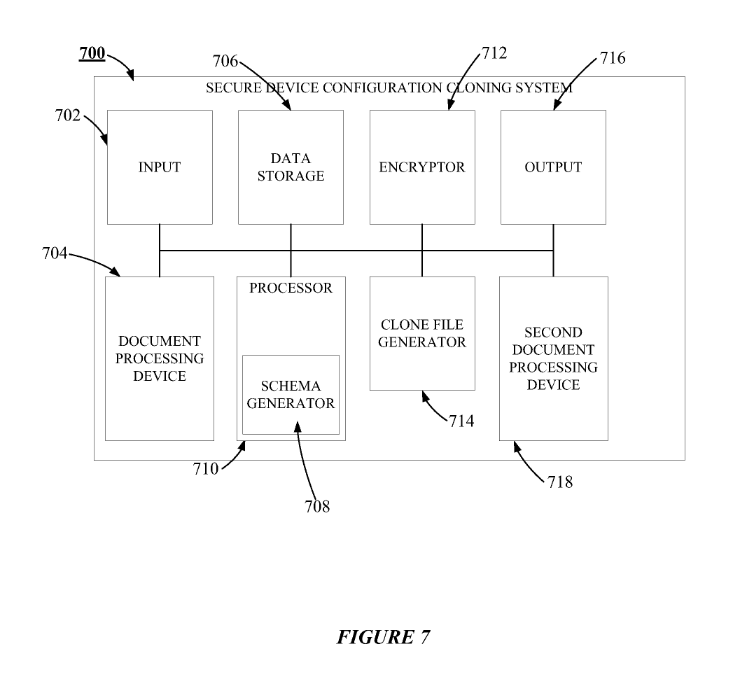

Referring now to FIG. 7, illustrated is a block diagram of a secure device configuration cloning system 700 in accordance with one embodiment of the subject application. As shown in FIG. 7, the secure device configuration cloning system 700 includes an input 702 that is configured to receive configuration data. According to one embodiment of the subject application, the configuration data corresponds to software-settable configurations of a document processing device 704, which are stored in a data storage 706. The system 700 further includes a schema generator 708 that is operable on a processor 710 in data communication with the data storage 706. Preferably, the schema generator 708 is configured to generate a schema file that has a plurality of segments, with the schema file corresponding to at least a portion of the configuration data.

In addition, the system 700 incorporates an encryptor 712, which is configured to encrypt at least one segment of the schema file based upon a corresponding portion of the configuration data. Also included in the secure device configuration cloning system 700 is a clone file generator 714. The clone file generator 714 is in operation so as to generate secure clone file data based upon the configuration data and the encrypted schema file. The system 700 further incorporates an output 716 that is configured to communicate the clone file data to a second document processing 718 device, which then uses the clone file data for its configuration.

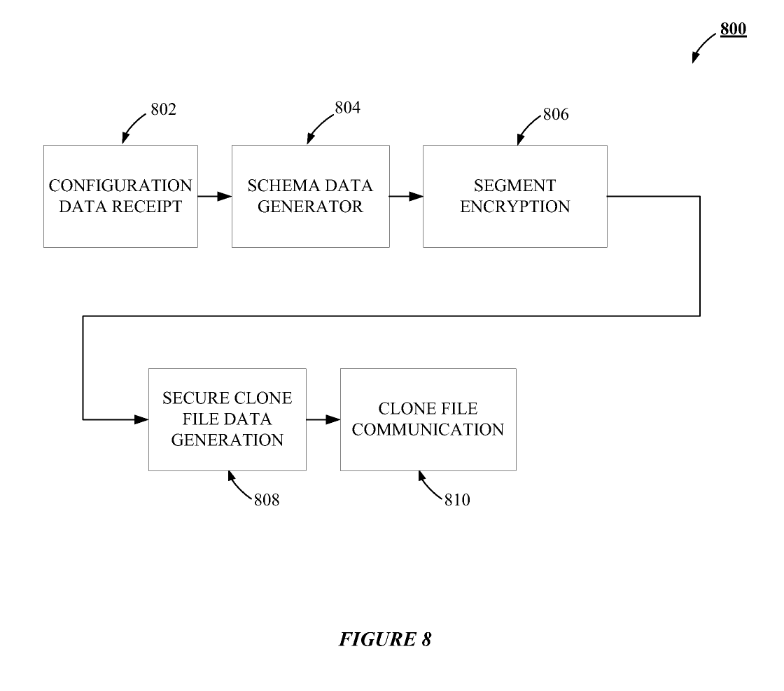

Turning now to FIG. 8, illustrated is a functional diagram of a system for secure device configuration cloning in accordance with one embodiment of the subject application. As shown in FIG. 8, configuration data receipt 802 first occurs of data that corresponds to software-settable configurations of a document processing device. The receipt 802 preferably occurs into a data storage.

Schema data generation 804 is then performed on a processor in data communication with the data storage. According to one embodiment of the subject application, the schema file includes segments, and corresponds to a portion of the configuration data. Segment encryption 806 is then performed on one or more segments of the schema file based upon a corresponding portion of the configuration data. Secure clone file data generation 808 then occurs in accordance with the configuration data and the encrypted schema file. Thereafter, clone file communication 810 then is performed of clone file data to a second document processing device for configuration thereof.

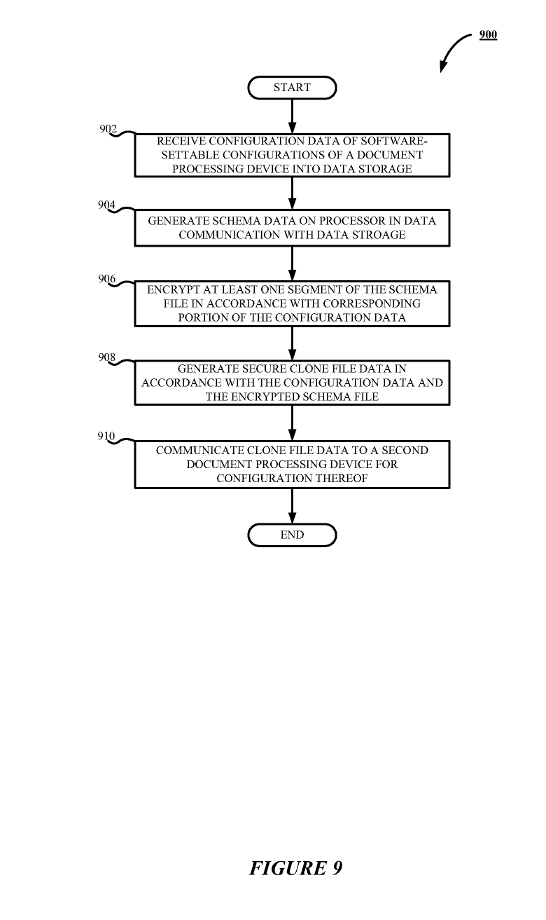

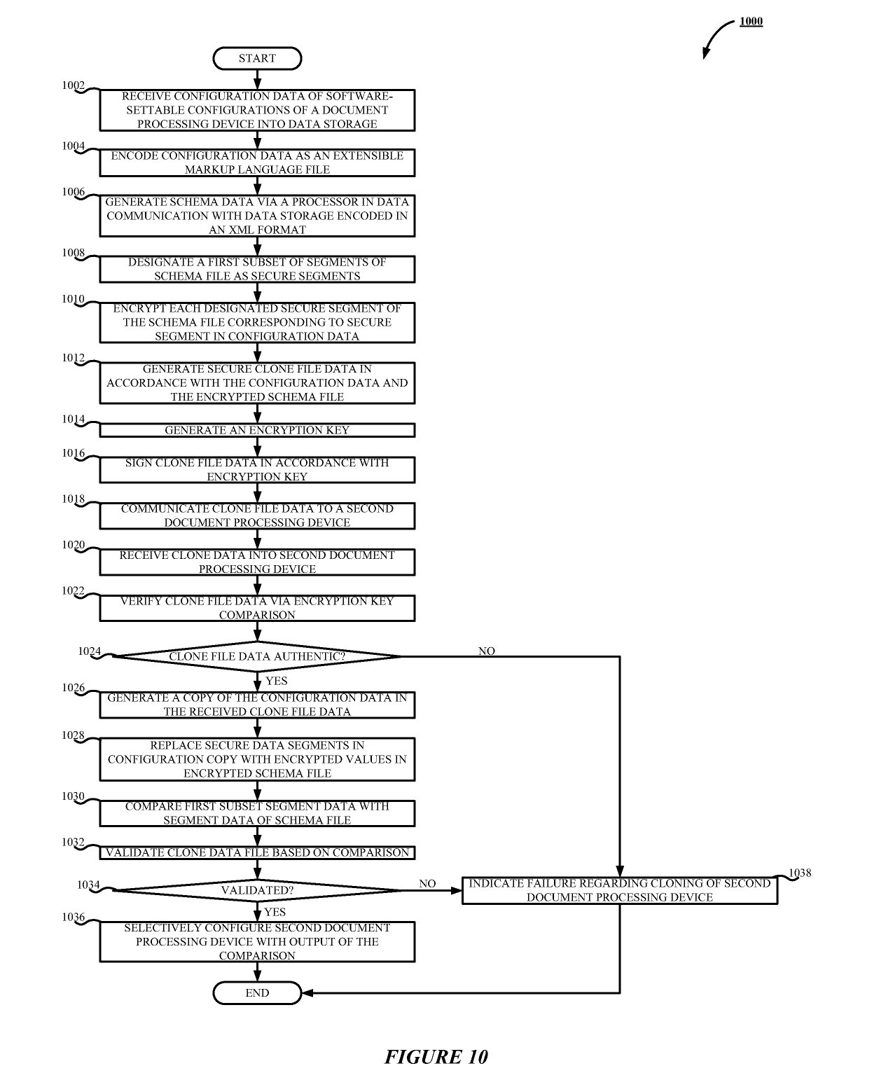

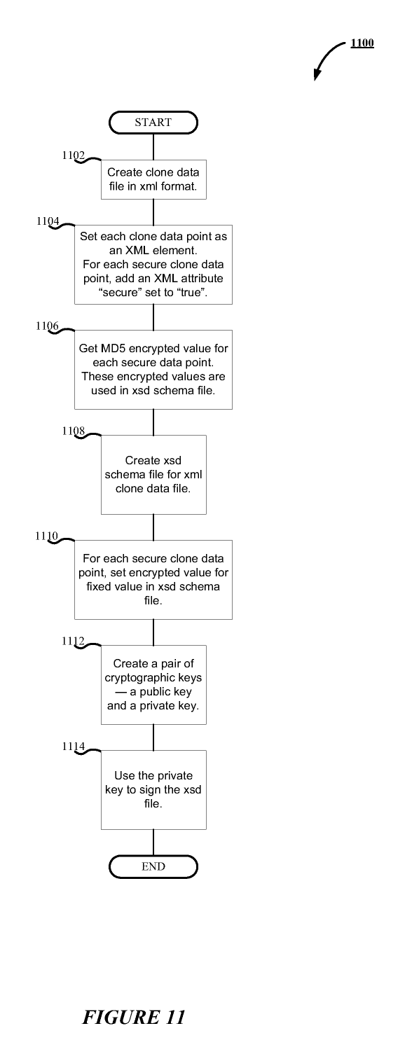

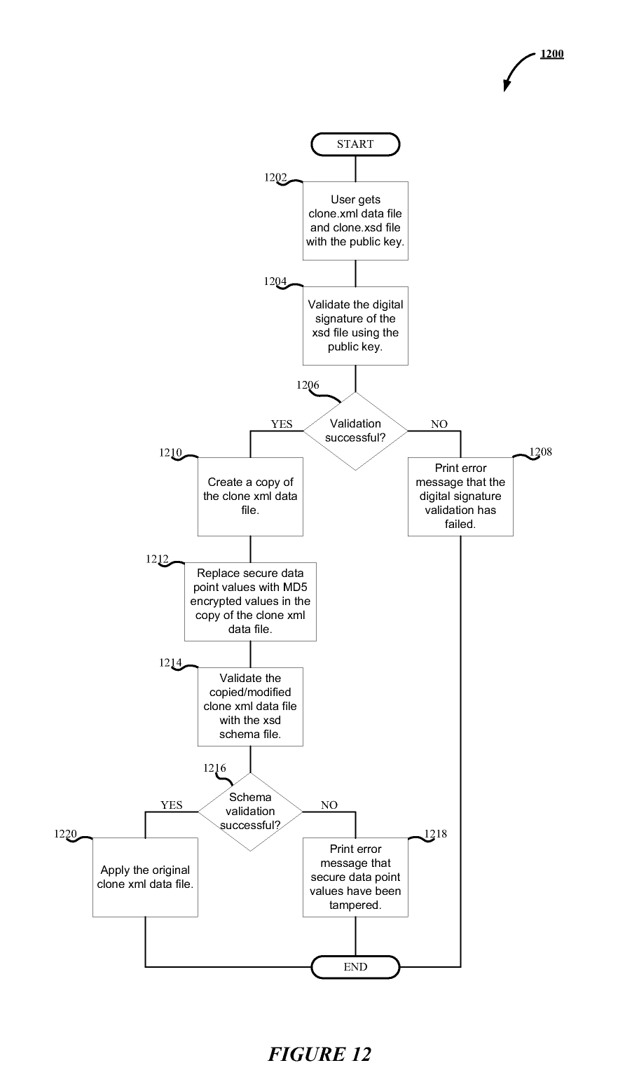

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10, as well as the example implementations of FIGS. 11 and 12. Turning now to FIG. 9, there is shown a flowchart 900 illustrating a secure device configuration cloning method in accordance with one embodiment of the subject application. Beginning at step 902, configuration data is received into a data storage, which data corresponds to software-settable configurations of a document processing device.

At step 904, schema data is generated via a processor in data communication with the data storage. In accordance with one embodiment of the subject application, the schema file includes a plurality of segments and corresponds to one or more portions of the configuration data. One or more segments of the schema file are then encrypted at step 906 in accordance with a corresponding portion of the configuration data. Secure clone file data is then generated based upon the configuration data and the encrypted schema file at step 908. Thereafter, at step 910, the clone file data is communicated to a second document processing device for configuration thereof.

Referring now to FIG. 10, there is shown a flowchart 1000 illustrating a secure device configuration cloning method in accordance with one embodiment of the subject application. The methodology of FIG. 10 begins at step 1002, whereupon configuration data corresponding to software-settable configurations of a document processing device is received into a data storage. In accordance with one embodiment of the subject application, the user device 134 and storage 136 facilitate the storage of the software-settable configurations of the document processing devices 104, 114, or 124. In accordance with another example embodiment of the subject application, the configuration data is stored on a source document processing device, e.g. the data storage device 110 of the first document processing device 104. It will be appreciated by those skilled in the art that such an implementation is capable of being used in place of or in addition to the use of the user device 134. Thus, reference is made hereinafter to either the data processing device, e.g. user device 134, or the controller 108 of the source device 104, as generating cloning data, as will be explained in greater detail below.

At step 1004, the configuration data is encoded as an extensible markup language (XML) file. Schema data is then generated at step 1006 by a processor in data communication with the data storage (110 or 136). Preferably, the schema data is encoded in an XML format, e.g. an extensible markup language schema data “.xsd” file format. According to the instant example embodiment, the schema file consists of a plurality of segments, and corresponds to at least a portion of the configuration data. In alternative embodiments, binary encoding or other encoding schemes may be used for the schema file. A first subset of the segments is designated as secure segments at step 1008. Thereafter, at step 1010, each segment of the schema file that corresponds to a secure segment in the configuration data is encrypted by the user device 134 or the controller 108, depending upon which device is facilitating the generation of the cloning data.

Secure clone file data is then generated at step 1012 in accordance with the configuration data and the encrypted schema file. The user device 136 or controller 108 associated with the source document processing device 104 then generates an encryption key at step 1014. It will be appreciated by those skilled in the art that such an encryption key is capable of implementation as a public-private key pair, or other such encryption key as are known in the art. The clone file data is then signed using the encryption key at step 1016. The skilled artisan will appreciate that the methodology involved in signing the clone file data is any suitable verification method known in the art, e.g. a digital signature or the like. At step 1018, the clone file data is communicated to a second document processing device, e.g. the document processing devices 114 or 124.

The clone data is then received into the second document processing device, e.g. the document processing device 114, at step 1020. For example purposes only, reference is made hereinafter to the second document processing device being the document processing device 114. The same processes may be applied simultaneously or in serial to multiple document processing devices. At step 1022, the clone file data is verified via encryption key comparison by the controller 118 or other suitable component associated with the second document processing device 114. A determination is then made at step 1024 whether the clone file data is authentic based upon the encryption key comparison. That is, the signature associated with the received file data is verified by the controller 118 or other suitable component of the second document processing device 118. Upon a negative determination at step 1024, flow proceeds to step 1038, whereupon a failure is indicated regarding the cloning on the second document processing device 114.

When it is determined at step 1024 that the clone file data is authentic, flow proceeds to step 1026. At step 1026, the controller 118 or other suitable component associated with the second document processing device 114 generates a copy of the configuration data in the received clone file data. Secure data segments in the configuration copy are then replaced at step 1028 with encrypted values in the encrypted schema file. A comparison of the first subset segment data with the segment data of the schema file is then performed at step 1030. The clone file data is then validated at step 1032 based upon the comparison performed at step 1030.

A determination is then made at step 1034 whether the clone file data has been validated. Upon a negative determination at step 1034, flow proceeds to step 1038 with an indication of the failure of the cloning operation on the second document processing device 114. Following successful validation at step 1034, the second document processing device 114 is selectively configured at step 1036 based upon the comparison output and the corresponding configuration data, as will be appreciated by those skilled in the art.

The preceding methodology of FIG. 10 will be better understood in conjunction with the example implementations set forth in the flowcharts 1100 and 1200 of FIGS. 11 and 12, respectively. Turning now to FIG. 11, there is shown a flowchart 1100 that illustrates the generation of a clone file on a source machine, i.e. the document processing device 104. At step 1102, a clone data file is first generated by the controller 108 or other suitable component associated with the document processing device 104 in XML format. Each clone data point is then set as an XML element at step 1104. Thus, for each secure clone data point, an XML attribute secure is added and set to true, e.g. <datapoint1secure=“true”>Value1</datapoint1>.

An MD5 encrypted value for each secure data point is then retrieved at step 1106 for use in generation of an .xsd schema file. At step 1108, an .xsd schema file is created corresponding to the XML clone data file. For each secure clone data point, the encrypted value is set for a fixed value in the .xsd schema file at step 1110. Preferably, for each secure data point element in the XML clone data file, the .xsd file has the corresponding xs:element with the attribute “fixed” set to MD5 encrypted value of that secure data point (e.g. <xs:element name=“datapoint1” type=“xs:string” fixed=“MD5Value1”/> where MD5Value1 is the MD5 encrypted value of Value1). The skilled artisan will appreciate that such MD5 encryption functions to prevent a user from using his/her own generated .xsd file for the validation (as discussed in greater detail below).

At step 1112, a pair of cryptographic keys, i.e. a public/private key pair, is generated via the controller 108 associated with the source document processing device 104. The .xsd file is then signed, at step 1114, using the private key generated at step 1112, thus rendering the clone file ready for communication/transmission/transport to a secondary document processing device, e.g. the document processing devices 114 and/or 124. In accordance with one embodiment of the subject application, the private key is stored securely, and a compressed file, i.e. a .zip file, is stored that consists of the XML clone data file, the .xsd file, and the public key is ready for communication to secondary devices 114 and/or 124.

Referring now to FIG. 12, there is shown a flowchart 1200 illustrating the implementation of the cloned configuration of FIG. 11 on one or more additional document processing devices 114 or 124. The methodology of FIG. 12 begins at step 1202, whereupon the user retrieves the clone data file, i.e. the XML clone file, using the public key of the cryptographic key pair. It will be appreciated by those skilled in the art that the retrieval of the XML clone file is capable of occurring via receipt of a suitable transmission from the source document processing device 104 to the recipient device 114 or 124, via installation of a portable storage medium, via network retrieval, via remote interactions, or the like.

At step 1204, the controller 118 or 128, or other suitable component associated with the additional document processing device 114 or 124 validates the digital signature of the .xsd file using the public key. A determination is then made at step 1206 whether the validation of the .xsd is successful. In the event that validation by the controller 118 or 128 is unsuccessful, flow proceeds to step 1208, whereupon an error message is displayed to the user installing the cloned configuration file, which message indicates the failed validation of the digital signature.

Upon a determination at step 1206 that validation was successful regarding the digital signature, flow proceeds to step 1210. At step 1210, a copy of the XML clone data file is created by the controller 118 or 128. The secure data point values in the copy of the clone XML data file are then replaced with MD5 encrypted values in that copied file at step 1212. The copied/modified XML clone data file is then validated with the .xsd schema file at step 1214. A determination is then made at step 1216 whether the schema validation performed at step 1214 is successful. Upon negative determination at step 1216, flow proceeds to step 1218, whereupon an error message is displayed to the user indicating that the secure data point values of the clone file have been tampered with and that installation is aborted. Upon a positive determination at step 1220, the original clone XML data file is applied to the document processing device 114 or 124.

Closing Comments

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A secure device configuration cloning system comprising:
an input operable to receive configuration data corresponding to software-settable configurations of a document processing device into a data storage;
a schema generator operable on a processor in data communication with the data storage, the schema generator being operable to generate a schema file having a plurality of segments, the schema file corresponding to at least a portion of the configuration data;
an encryptor operable to encrypt at least one segment of the schema file in accordance with a corresponding portion of the configuration data;
a clone file generator operable to generate secure clone file data in accordance with the configuration data and the encrypted schema file; and
an output operable to communicate the clone file data to a second document processing device for configuration thereof.

2. The system of claim 1 wherein the configuration data includes a plurality of segments, wherein a first subset of the segments are designated as secure, and wherein the encryptor is further operable to encrypt each segment of the schema file that corresponds to a secure segment in the configuration data.

3. The system of claim 2 wherein the configuration data is encoded as an extensible markup language (XML) file, and wherein the schema file is encoded as an XML schema file.

4. The system of claim 3 further comprising:
a key generator operable to generate an encryption key; and
a signer operable to sign the clone file data in accordance with the encryption key.

5. The system of claim 2 further comprising the second document processing device including:
a clone file data input operable to receive the clone file data;
a comparator operable to compare data associated with the first subset of segments with data associated with the segments of the schema file; and
a validator operable to validate received clone data file in accordance with an output of the comparator.

6. The system of claim 5 further wherein the second document processing device further comprises:
a file copier operable to generate a copy of configuration data in the received clone file data;
a file modifier operable to replace secure data segments in the copy of configuration data with encrypted values in the encrypted schema file; and
wherein the comparator is operable in conjunction with the copy of the configuration data.

7. The system of claim 6 wherein the second document processing device further comprises a configurator operable for selective configuration thereof in accordance with an output of the comparator.

8. A secure device configuration cloning method comprising the steps of:
receiving configuration data corresponding to software-settable configurations of a document processing device into a data storage;
generating schema data on a processor in data communication with the data storage, the schema file having a plurality of segments, the schema file corresponding to at least a portion of the configuration data;
encrypting at least one segment of the schema file in accordance with a corresponding portion of the configuration data;
generating secure clone file data in accordance with the configuration data and the encrypted schema file; and
communicating the clone file data to a second document processing device for configuration thereof.

9. The method of claim 8 wherein the configuration data includes a plurality of segments, wherein a first subset of the segments are designated as secure, and further comprising encrypting each segment of the schema file that corresponds to a secure segment in the configuration data.

10. The method of claim 9 further comprising encoding the configuration data as an extensible markup language (XML) file, and wherein the schema file is encoded as an XML schema file.

11. The method of claim 10 further comprising:
generating an encryption key; and
signing the clone file data in accordance with the encryption key.

12. The method of claim 9 further comprising:
receiving the clone file data into a second document processing device;
comparing data associated with first subset of segments with data associated with the segments of the schema file; and
validating received clone data file in accordance with an output of the comparison.

13. The method of claim 12 further comprising:
generating a copy of configuration data in the received clone file data;
replacing secure data segments in the copy of configuration data with encrypted values in the encrypted schema file; and
wherein comparing includes comparing with the copy of the configuration data.

14. The method of claim 13 further comprising selectively configuring the second document processing device in accordance with an output of the comparator.

15. A secure device configuration cloning system comprising:
means adapted for receiving configuration data corresponding to software-settable configurations of a document processing device into a data storage;
means adapted for generating schema data on a processor in data communication with the data storage, the schema file having a plurality of segments, the schema file corresponding to at least a portion of the configuration data;
means adapted for encrypting at least one segment of the schema file in accordance with a corresponding portion of the configuration data;
means adapted for generating secure clone file data in accordance with the configuration data and the encrypted schema file; and
means adapted for communicating the clone file data to a second document processing device for configuration thereof.

16. The system of claim 15 wherein the configuration data includes a plurality of segments, wherein a first subset of the segments are designated as secure, and further comprising means adapted for encrypting each segment of the schema file that corresponds to a secure segment in the configuration data.

17. The system of claim 16 further comprising means adapted for encoding the configuration data as an extensible markup language (XML) file, and wherein the schema file is encoded as an XML schema file.

18. The system of claim 17 further comprising:
means adapted for generating an encryption key; and
means adapted for signing the clone file data in accordance with the encryption key.

19. The system of claim 16 further comprising:
means adapted for receiving the clone file data into a second document processing device;
means adapted for comparing data associated with first subset of segments with data associated with the segments of the segments of the schema file; and
means adapted for validating received clone data file in accordance with an output of the comparator.

20. The system of claim 19 further comprising:
means adapted for generating a copy of configuration data in the received clone file data;
means adapted for replacing secure data segments in the copy of configuration data with encrypted values in the encrypted schema file; and
wherein means adapted for comparing includes means adapted for comparing with the copy of the configuration data.

21. The method of claim 20 further comprising means adapted for selectively configuring the second document processing device in accordance with an output of the comparator.
